(19) United States
(12) Patent Application Publication
(10) Pub. No.: US 2011/0308003 A1
(43) Pub. Date: Dec. 22, 2011

(54) Spa Having A Retractable Cover

(75) Inventor: Ian P. A. Scali, Ontario, CA (US)

(73) Assignee: Sundance Spas, Inc., Chino Hills, CA (US)

(21) Appl. No.: 13/162,012

(22) Filed: Jun. 16, 2011

Related U.S. Application Data
(60) Provisional application No. 61/355,636, filed on Jun. 17, 2010.

(51) Int. Cl. E04H 4/00; E06B 9/08; E04H 4/08; E06B 9/04; E05F 15/06

(52) U.S. Cl. 4/498; 160/221; 160/133

(57) ABSTRACT

An articulating cover member for covering an opening, such as a spa, includes a plurality of pivotally connected door panels wherein each of the door panels include at least one longitudinally-extending tubular member and at least one longitudinally-extending attachment member associated with a longitudinal edge portion of the at least one tubular member. The at least one longitudinally-extending attachment member is configured for cooperation with an attachment member extending along a longitudinal edge portion of the tubular member of an adjacent door panel for pivotally connecting the door panels. An insulating material may be located within the tubular members and a motor assembly may be provided for automatic actuation of the cover member.

### CROSS REFERENCE TO RELATED APPLICATION

This application claims priority to U.S. Provisional Patent Application No. 61/355,636, filed Jun. 17, 2010, which is incorporated herein by reference.

### BACKGROUND OF THE INVENTION

1. Field of the Invention

This invention relates to a retractable cover for use with a spa or tub. More specifically, the invention relates to an automatically extendable/retractable cover for easy manipulation and storage thereof.

2. Description of Related Art

The use of covers for covering outdoor water containment vessels such as spas, tubs, and whirlpools has been known as a means for preventing the introduction of unwanted airborne debris into the vessels. Also, covers are often used as a safety measure to prevent access into the vessels and prevent accidental drowning/injury to children or small animals.

These covers are typically designed to be manually manipulated into place and manually removed by the user. This manual manipulation of the cover can be awkward and cumbersome. Moreover, providing suitable storage of the cover can also present a problem. Automatic and/or semi-automatic systems for removable covers for spas and pools have been developed. Representative examples of these covers are disclosed in U.S. Pat. Nos. 4,271,542; 5,303,527; 6,718,566; and 7,412,733. These systems often employ complex linkages and equipment including hydraulic lifts and jacks, are expensive to manufacture, require a large amount of space to store the removed cover, and fail to provide little, if any, heat insulation to the contents of the spa/pool.

The present invention is directed to a retractable cover assembly which effectively insulates and retains the heat of the vessel contents while preventing the introduction of airborne debris inside the vessel. The present invention further provides a safety feature against accidental drowning by preventing access into the vessel. Still yet, the present invention allows for the automatic manipulation of the cover such that it can be retracted, rolled upon itself, and stored in an unobtrusive location.

### SUMMARY OF THE INVENTION

According to one embodiment, the invention is directed to an articulating cover member for covering an opening, such as an opening for a spa or tub. The cover member may include a plurality of pivotally connected door panels. Each of the door panels may have at least one longitudinally-extending tubular member and at least one longitudinally-extending attachment member associated with a longitudinal edge portion of the at least one tubular member. The at least one longitudinally-extending attachment member may be configured for cooperation with an attachment member extending along a longitudinal edge portion of the tubular member of an adjacent door panel for pivotally connecting the door panels. A track assembly may be provided for guiding the movement of the cover member with respect to a frame of an opening. According to one embodiment, each of the door panels may include a pair of tubular members and an interposed support member extending between and parallel with the pair of tubular members, and the at least one attachment member may include a male member extending along a first longitudinal edge of one of the pair of tubular members and a female member extending along a second longitudinal edge of the other of the pair of tubular members. The male member may be configured for cooperation with an adjacent door panel female member and the female member may be configured for cooperation with an adjacent door panel male member. Desirably, each of the door panels may be a single extruded piece. An insulating material can be located within the tubular members. If desired, a motor assembly may be provided for automatic actuation of the cover member.

According to another embodiment, the invention is directed to an automated retractable cover assembly for a water containment vessel, such as a spa. The cover assembly may include a plurality of pivotally connected door panels, each of the door panels including at least one longitudinally-extending tubular member and at least one longitudinally-extending attachment member associated with a longitudinal edge portion of the at least one tubular member. The at least one longitudinally-extending attachment member may be configured for cooperation with an attachment member extending along a longitudinal edge portion of the tubular member of an adjacent door panel for pivotally connecting the door panels. A track and motor assembly may be provided for controlling movement of the plurality of door panels to extend or retract the cover with respect to an opening of the spa. According to one embodiment, the at least one tubular member may include a pair of tubular members and an interposed support member extending between, and parallel with the pair of tubular members. The at least one attachment member may include a male member extending along a first longitudinal edge of the at least one tubular member and a female member extending along a second longitudinal edge of the at least one tubular member, wherein the male member may be configured for cooperation with an adjacent door panel female member and the female member may be configured for cooperation with an adjacent door panel male member. An insulating material, such as polyurethane foam, may be placed within the at least one tubular member. According to one desirable manufacturing technique, each of the door panels may be a single extruded piece and the foam material may be injected into the tubular members and formed in situ. The door panels may be formed from any well known, extrudable material such as metal, plastic, composite material, and the like. Preferably, the extrudable material may include an aluminum material. The cover may extend and retract through an opening in the sidewall of the spa and may be rolled upon itself for storage in a location beneath the spa.

According to another embodiment, the invention is directed to a spa including a water containment shell having a bottom closed portion, an open top portion, and a sidewall portion extending between the open top portion and the bottom closed portion to define a containment area. A top ledge portion may be provided adjacent the sidewall portion defining a user access into the water containment shell. A side opening may extend through the top ledge portion. A retractable cover may be provided for extension and retraction through a side opening. The retractable cover may include a plurality of pivotally connected door panels. Each of the door panels may have at least one longitudinally-extending tubular member and at least one longitudinally-extending attachment member associated with a longitudinal edge portion of the at least one tubular member. The at least one longitudinally-extending attachment member may be configured for cooperation with an attachment member extending along a longitudinal edge portion of a tubular member of an adjacent door panel for pivotally connecting the door panels. The spa further may include a storage space located adjacent the water containment shell for receiving the retractable cover in a retracted/stored position. According to one embodiment, a shroud may be provided adjacent this storage space for covering the retracted/stored cover. The spa can also include a track for guiding movement of the plurality of door panels to extend or retract the cover with respect to an opening of the spa. A motor may be provided for automatically controlling movement of the cover along the track. According to a further embodiment, a railing may be provided that extends around the water containment shell. The railing may be configured for folding in a downward direction to facilitate debris removal, such as snow or leaves from a top surface of the cover.

These and other features and characteristics of the present invention, as well as the methods of operation and functions of the related elements of structures and the combination of parts and economies of manufacture will become more apparent upon consideration of the following description with reference to the accompanying drawings, all of which form a part of this specification, wherein like reference numerals designate corresponding parts in the various figures.

### BRIEF DESCRIPTION OF THE DRAWINGS

FIG. 1 is a top perspective view of a spa including a cover of one embodiment of the invention in a partially retracted position;

FIG. 2A shows a perspective view of a spa including a cover of one embodiment of the invention in a fully extended/covering position;

FIGS. 2B-2C show perspective views of the cover of FIG. 2A in partially retracted positions;

FIG. 3 shows a side perspective view of one type of a spa adapted for using a cover of one embodiment of the present invention;

FIG. 4 shows a perspective view of one door panel of the cover of FIGS. 1 and 2A-2C;

FIG. 5 shows an end view of the door panel of FIG. 1;

FIG. 6 shows a plurality of the door panels of FIG. 1 pivotally connected to form part of the cover of FIGS. 1 and 2A-2C;

FIG. 7 shows the cover of FIG. 5 wherein the door panels are wrapped about a drum surface;

FIG. 8 shows a cross-sectional side view of a frame for a spa including a rolled up cover of one embodiment of the invention in a stored location with respect to the spa;

FIG. 9 shows a cover of one embodiment of the invention in an extended position with one type of a spa design;

FIG. 10 shows a cover of one embodiment of the invention in a partially retracted position with another type of spa design; and

FIG. 11 shows a cross-sectional side view of a track assembly integrally molded into a sidewall of a containment shell of a spa.

### DETAILED DESCRIPTION OF THE INVENTION

For purposes of the description hereinafter, spatial or directional terms shall relate to the invention as it is oriented in the drawing figures. However, it is to be understood that the invention may assume various alternative variations, except where expressly specified to the contrary. It is also to be understood that the specific components illustrated in the attached drawings, and described in the following specification, are simply exemplary embodiments of the invention. Hence, specific dimensions and other physical characteristics related to the embodiments disclosed herein are not to be considered as limiting.

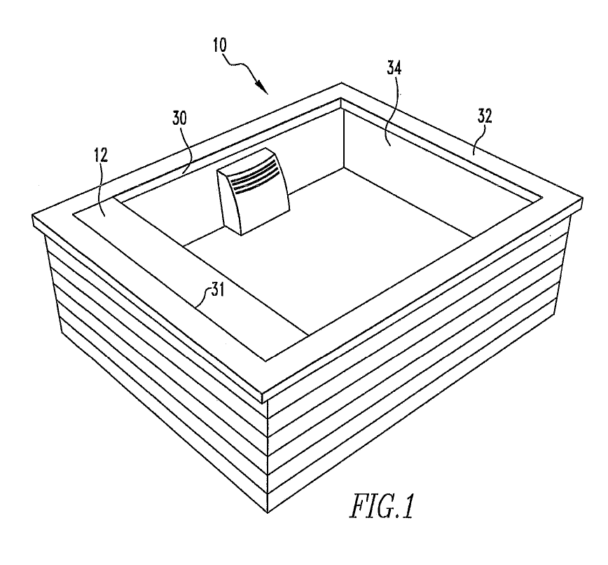

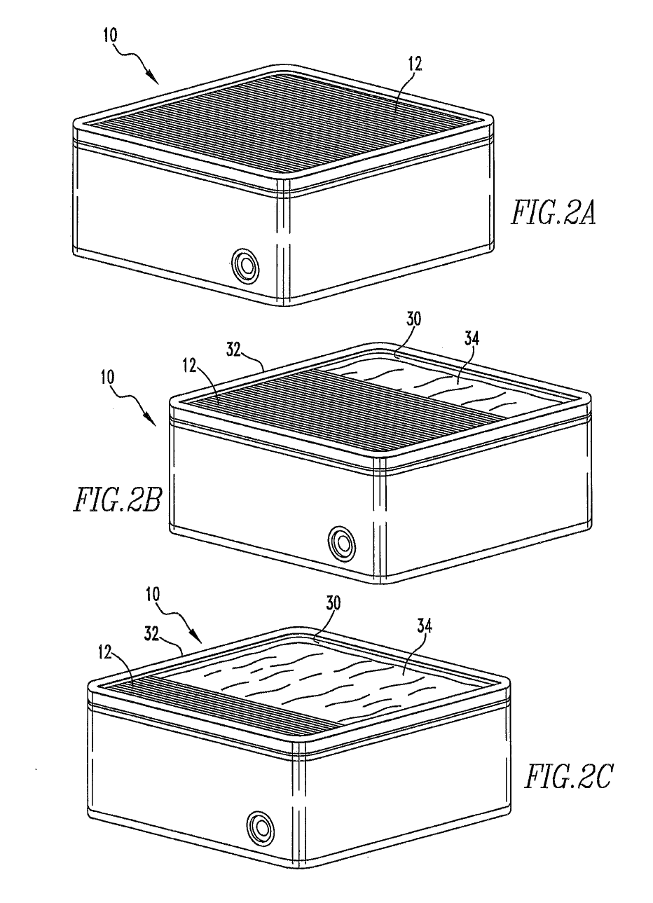

Reference is now made to FIG. 1 and FIGS. 2A-2C which show a spa, generally indicated as 10, including a retractable cover 12 according to the present invention, in various stages of extension and retraction for covering the opening of the spa. It is recognized that retractable cover 12 of the invention is not limited to spas, but could be used for closing a variety of openings including pools, whirlpool baths, and the like, as well as other types of openings defined by a frame, such as sheds, garages, and the like.

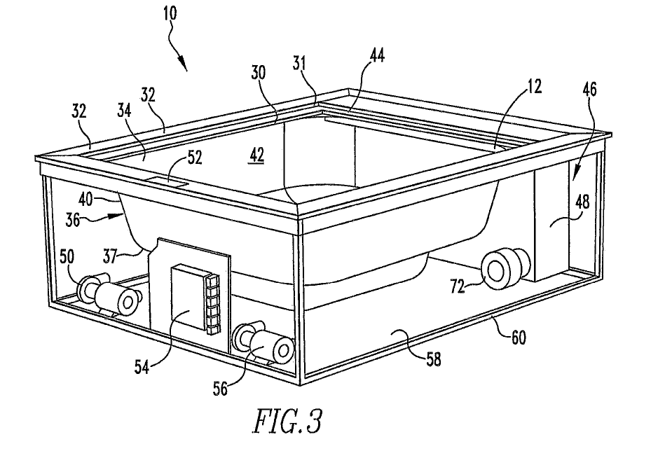

With reference to FIG. 3, spa 10 includes a water containment shell 36 having a closed bottom portion 37, an open top portion 34, and a sidewall portion 40 extending between open top portion 34 and closed bottom portion 37 to define a containment area 42. A top ledge portion or frame 32 is provided adjacent to sidewall portion 40 defining a user access into water containment shell 36. A side opening 44 extends through the top sidewall portion 31 of the top ledge portion or frame 32. Retractable cover 12, as discussed in greater detail hereafter, is configured for extension and retraction through side opening 44.

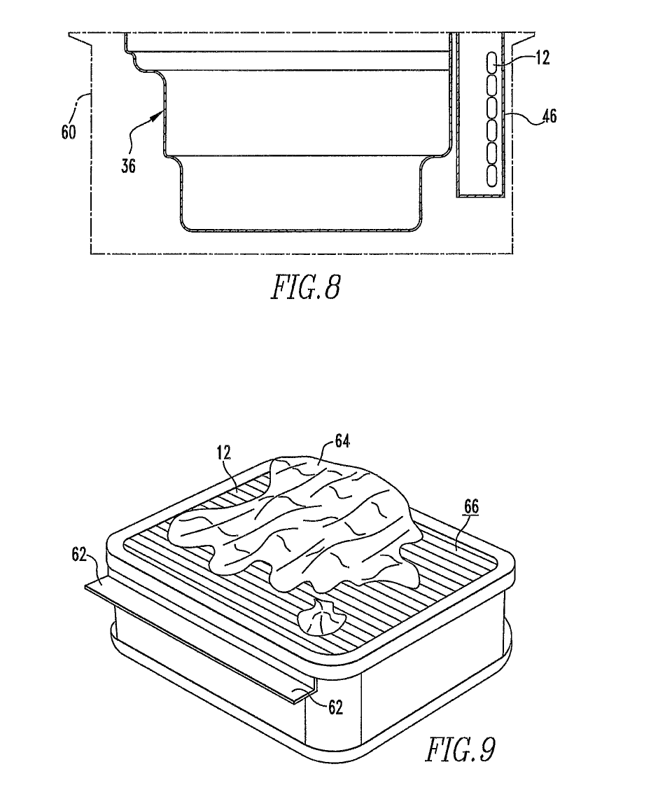

Spa 10 further includes a storage space, generally indicated as 46 in FIGS. 3 and 8, located adjacent the location of water containment shell 36 for receiving retractable cover 12 in a retracted/stored position. The articulating design of retractable cover 12 allows for door panels 14 to roll upon themselves upon retraction for compacted storage of retractable cover 12. In one embodiment, door panels 14 of retractable cover 12 are rolled around a tubular shaft 47. According to one embodiment, a shroud 48 is provided adjacent to storage space 46 for covering retractable cover 12. As further discussed below, track assembly 30 is provided for guidance of retractable cover 12, and a motor assembly 72 can be provided for automatically controlling movement of retractable cover 12 along track assembly 30. Spa 10 of FIG. 3 also shows many components common to spas including jet pumps 50, a control panel 52, a control box 53, heater 54, a circulation pump 56, a synthetic pan 58, and a steel frame 60. Control panel 52 may be used for controlling automated deployment of retractable cover 12. Various comfort components, such as built-in pillow and multiple jets for achieving a desired massaging effect, can also be included.

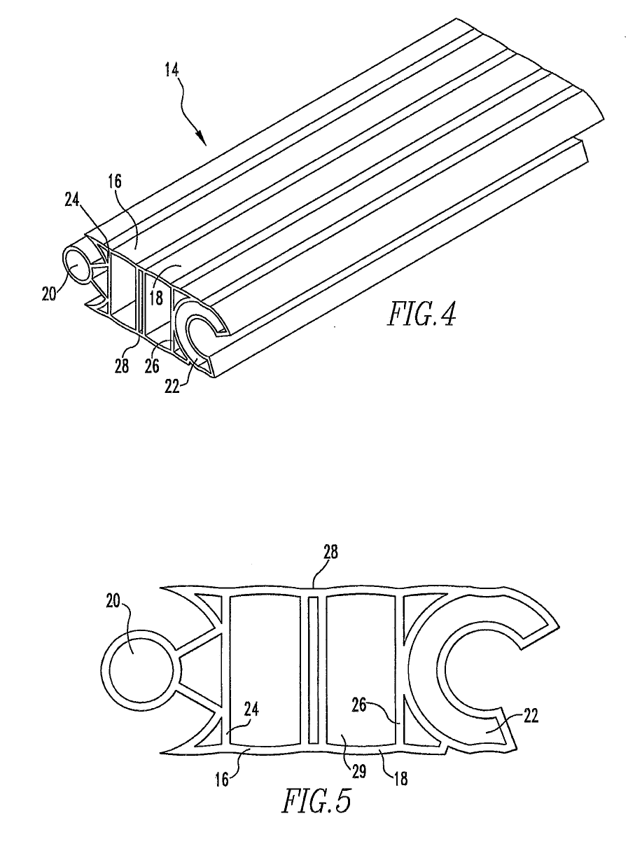

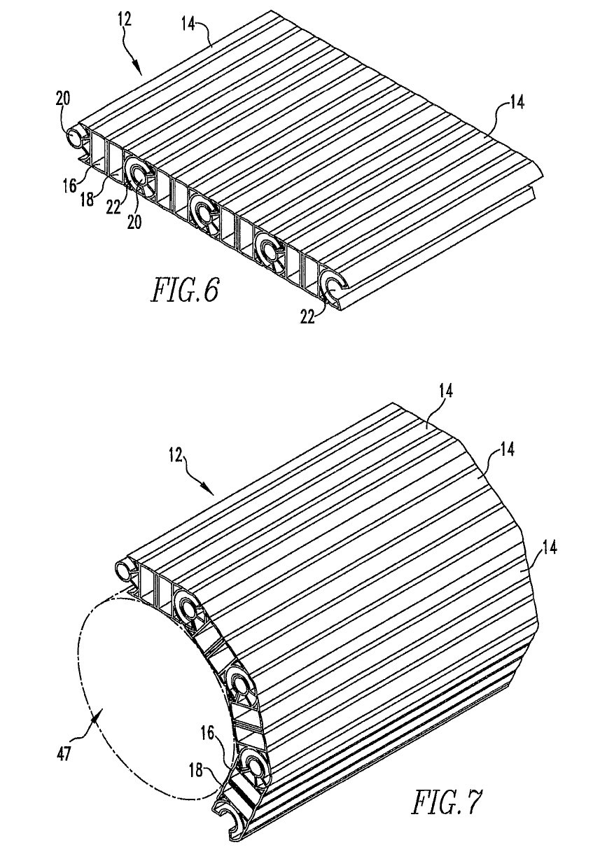

Reference is now made to FIGS. 4-7 which show retractable cover member 12 of the invention for covering an opening of spa 10. Retractable cover 12 includes a plurality of pivotally connected door panels, generally indicated as 14 in FIGS. 6 and 7. Each door panel 14 includes at least one longitudinally-extending tubular member, preferably a pair of tubular members 16, 18, and at least one longitudinally-extending attachment member, preferably a male and female attachment members 20, 22 associated with longitudinal edge portions 24, 26 of tubular members 16, 18. Male attachment member 20 is configured for cooperating with female attachment member 22 extending along a longitudinal edge portion 26 of a tubular member 16 of an adjacent door panel 14 in a tongue/groove arrangement for pivotally connecting or providing an articulating connection of door panel 14, as shown in FIGS. 6 and 7. The pair of tubular members 16, 18 can include an interposed support/bracket member 28 extending between and parallel with the pair of tubular members 16, 18.

One desirable manufacturing process for forming cover 12 is to extrude each door panel 14 as a single extruded piece. The material used for forming door panel 14 can be any well-known, extrudable material including metals, plastics/polymers, composites, and the like. Preferably, each door panel 14 is formed from an aluminum material. An insulating material 29 can be located within tubular members 16, 18. This insulating material can be any well-known type of material, but preferably a foam material, such as polyurethane foam, that can be injected into tubular members 16, 18 of each door panel 14 and formed in situ.

Referring back to FIG. 3, a track assembly 30 is provided for guiding the movement of retractable cover 12 through an opening 34 in a top sidewall portion 31. Such movement of retractable cover 12 occurs with respect to a frame 32 surrounding opening 34 of spa 10. According to one embodiment, retractable cover 12 may be manually actuated. According to another embodiment, retractable cover 12 may be automatically actuated via a motor assembly 72 to achieve automatic retraction or extension of retractable cover 12. The motor assembly used with retractable cover 12 may be any track and motor assembly well-known in the art. Actuation of retractable cover 12 may be achieved via remote control (not shown) or a control panel 52 mounted on or near the spa 10. One desirable embodiment of track assembly 30 is shown in detail in FIG. 11.

Referring now to FIG. 11, there is shown a cross-sectional side view of containment shell 36 according to an embodiment of the invention. Track assembly 30 and a longitudinally-extending opening are integrally molded into top sidewall portion 31 of containment shell 36. Retractable cover 12 runs along this opening of track assembly 30.

According to a further embodiment shown in FIG. 9, a railing 62 can be provided around water containment shell 36. Railing 62 is configured for folding in a downward direction to facilitate removal of debris 64, such as snow or leaves, from a top surface 66 of retractable cover 12.

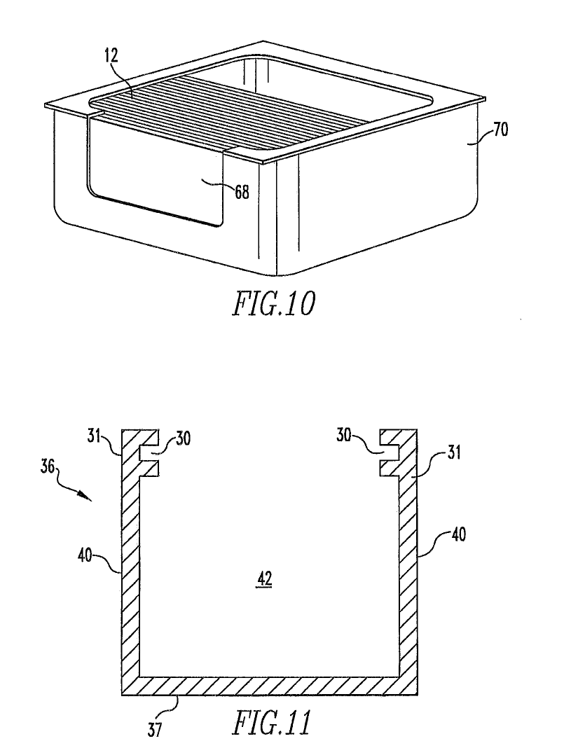

Reference is now made to FIG. 10 which shows another embodiment of spa 10 for which retractable cover 12 of the invention can be used. In this embodiment, a transparent panel 68 is provided which allows for a transparent view into spa 10. This embodiment can also include a variety of decorative panels 70 to customize the spa 10 to any décor.

Retractable cover 12 described herein provides for an efficient and easy-to-use cover system that effectively insulates and retains the heat of spa 10 contents while preventing the introduction of airborne debris inside spa 10. Retractable cover 12 is also inexpensive to produce, can be easily customized to fit any size containment shell 36, and can be automatically retracted, rolled upon itself, and stored in an unobtrusive location.

The present invention has been described with reference to the preferred embodiments. Obvious modifications and alterations will occur to others upon reading and understanding the preceding detailed description. It is intended that the invention be construed as including all such modifications and alterations.

The invention claimed is:

1. An articulating cover member for covering an opening, said cover member comprising:
a plurality of pivotally connected door panels, each of said door panels comprising at least one longitudinally-extending tubular member and at least one longitudinally-extending attachment member associated with a longitudinal edge portion of said at least one tubular member, said at least one longitudinally-extending attachment member configured for cooperation with an attachment member extending along a longitudinal edge portion of a tubular member of an adjacent door panel for pivotally connecting said door panels; and
a track assembly for guiding movement of said cover member with respect to a frame of an opening.

2. The cover member of claim 1, wherein each of said at least one tubular member comprises a pair of tubular members and an interposed support member extending between and parallel with, said pair of tubular members.

3. The cover member of claim 2, wherein said at least one attachment member comprises a male member extending along a first longitudinal edge of said at least one tubular member and a female member extending along a second longitudinal edge of said at least one tubular member, wherein said male member is configured for cooperation with an adjacent door panel female member and said female member is configured for cooperation with an adjacent door panel male member.

4. The cover member of claim 3, wherein each of said door panels is a single extruded piece.

5. The cover member of claim 4, wherein an insulating material is positioned within said at least one tubular member.

6. The cover member of claim 1, including a motor assembly for automatic actuation of said cover member.

7. An automated retractable cover assembly for a spa, said cover assembly comprising:
a plurality of pivotally connected door panels, each of said door panels including at least one longitudinally-extending tubular member and at least one longitudinally-extending attachment member associated with a longitudinal edge portion of said at least one tubular member, said at least one longitudinally-extending attachment member configured for cooperation with an attachment member extending along a longitudinal edge portion of tubular member of an adjacent door panel for pivotally connecting said door panels; and
a track and motor assembly for controlling movement of said plurality of door panels to extend or retract said cover with respect to an opening of said spa.

8. The cover assembly of claim 7, wherein each of said at least one tubular member comprises a pair of tubular members.

9. The cover assembly of claim 8, wherein said pair of tubular members include an interposed support member extending between, and parallel with, said pair of tubular members.

10. The cover assembly of claim 7, wherein said at least one attachment member comprises a male member extending along a first longitudinal edge of said at least one tubular member, and a female member extending along a second longitudinal edge of said at least one tubular member, wherein said male member is configured for cooperation with an adjacent door panel female member and said female member is configured for cooperation with an adjacent door panel male member.

11. The cover assembly of claim 7, wherein an insulating material is positioned within said at least one tubular member.

12. The cover assembly of claim 11, wherein said insulating material comprises a polyurethane foam material.

13. The cover assembly of claim 7, wherein each of said door panels is a single extruded piece.

14. The cover assembly of claim 7, wherein said door panels are formed from one of a metal, plastic, and composite material.

15. The cover assembly of claim 7, wherein said cover retracts to form a rolled member for storage below said spa.

16. The cover assembly of claim 7, wherein said cover extends through an opening in the sidewall of the spa.

17. A spa comprising:
a water containment shell having a bottom closed portion, an open top portion, and a sidewall portion extending between said open top portion and said bottom closed portion to define a containment area;
a top ledge portion adjacent said sidewall portion defining a user access into said water containment shell;
a side opening extending through said top ledge portion;
a retractable cover configured for extension and retraction through said side opening, said retractable cover comprising a plurality of pivotally connected door panels, each of said door panels including at least one longitudinally-extending tubular member and at least one longitudinally-extending attachment member associated with a longitudinal edge portion of said at least one tubular member, said at least one longitudinally-extending attachment member configured for cooperation with an attachment member extending along a longitudinal edge portion of a tubular member of an adjacent door panel for pivotally connecting said door panels;
a storage space located adjacent said water containment shell for receiving said retractable cover in a retracted/stored position; and
a shroud adjacent said storage space for covering said retracted/stored cover.

18. The spa of claim 17, including a track for guiding movement of said plurality of door panels to extend or retract said cover with respect to an opening of said spa.

19. The spa of claim 18, wherein the track is an integrally molded opening extending through a top portion of the sidewall portion of the water containment shell.

20. The spa of claim 18, further comprising a motor for automatically controlling movement of said cover along said track.
